(19) United States
(12) Patent Application Publication
(10) Pub. No.: US 2015/0103552 A1
(43) Pub. Date: Apr. 16, 2015

(54) LIGHT SOURCE DEVICE AND VEHICULAR LAMP

(71) Applicant: KOITO MANUFACTURING CO., LTD., Tokyo (JP)

(72) Inventor: Yoshiaki Aiso, Shizuoka (JP)

(21) Appl. No.: 14/509,154

(22) Filed: Oct. 8, 2014

(30) Foreign Application Priority Data
Oct. 16, 2013 (JP) 2013-215155

(51) Int. Cl. F21S 8/10; F21V 29/00

(52) U.S. Cl. CPC F21S 48/32; F21V 29/004; F21S 48/115
USPC 362/549; 362/382

(57) ABSTRACT

A light source device has a light-emitting element structure body having a light-emitting element, a base member configured to be fitted in a lamp, and an installation portion disposed on the base member. The light-emitting element structure body is installed on the installation portion. The base member has a heat dissipation chamber communicating with an outside of the device. The heat dissipation chamber is formed inside the installation portion.

### BACKGROUND

1. Technical Field

The present invention relates to a light source device of a lamp installed in a vehicle such as an automobile and more particularly to a light source device of which heat dissipation effect has been increased and to a vehicular lamp including the light source device.

2. Related Art

There has been proposed, as a light source of a vehicular lamp, a light source device including a semiconductor light-emitting element such as an LED. In this type of light source device, particularly a light source device including an LED, thermal run-away is caused when the LED itself overheats due to heat generated by the LED. Accordingly, the light-emitting characteristics of the LED are deteriorated, or lifetime of the LED is shortened. Patent Document 1 describes a technology in which a heat dissipation member is accommodated in a lamp boss of the light source module structured including an LED, and the lamp boss facing the heat dissipation member is provided with heat dissipation holes. According to this technology, the heat generated by the LED is transferred to the heat dissipation member, and dissipated to the outside air through the heat dissipation holes of the heat dissipation member.

### Patent Document 1

Utility Model Registration No. 3182007

### SUMMARY

It is assumed that the light source module according to the technology of Patent Document 1 is mounted on the socket that is separately provided. Therefore, the light source module is disposed inside the lamp housing isolated from the outside air when the light source module is mounted on the vehicular lamp having a sealed lamp housing structured by a lamp body and a front lens. Accordingly, when light is emitted from the light source module, air is circulated only inside the lamp housing even though the heat is dissipated from the heat dissipation member with the air flowing through the heat dissipation holes provided in the lamp boss. As the time elapses, temperature of the air inside the lamp housing increases, and the heat dissipation effect gradually decreases. As described above, in the light source module described in Patent Document 1, the heat dissipation effect is insufficient even though it includes the heat dissipation member and the heat dissipation holes. Therefore, it is difficult to effectively prevent the LED from overheating.

One or more embodiments of the present invention provides a light source device and a vehicular lamp that enable heat to be dissipated by air at a low temperature while the light source device is mounted on the lamp and that have excellent heat dissipation effect.

According to one or more embodiments of the present invention, a light source device includes a light-emitting element structure body including a light-emitting element, a base member fitted in a lamp, and an installation portion which is provided in the base member and on which the light-emitting element structure body is installed. The light source device is characterized in that a heat dissipation chamber communicating with an outside of the light source device in the base member is formed inside the installation portion.

In one or more embodiments of the present invention, a high thermal conductive member partially exposed at the outside the device is provided or disposed in the heat dissipation chamber. In one or more embodiments of the present invention, a heat dissipation hole is provided in the base member so that the heat dissipation chamber communicates with the outside of the device. Particularly, in one or more embodiments of the present invention, the base member is mounted on a part of a member that separates the lamp chamber into a front side chamber and a rear side chamber, and in a state where the base member is mounted on the part of the member, the light-emitting element is positioned in the front side chamber of the lamp, and the heat dissipation chamber communicate with the rear side chamber of the lamp.

A vehicular lamp according to one or more embodiments of the present invention is comprises the light source device according to one or more embodiments of the present invention.

According to one or more embodiments of the present invention, the heat generated when the light-emitting element emits light is transferred from the light-emitting element structure body to the installation portion. The heat dissipation chamber is formed inside the installation portion. The heat dissipation chamber communicates with the outside of the light source device in the base member. Therefore, in the installation portion having an inner surface in contact with the heat dissipation chamber, the heat is dissipated by an air flowing through the heat dissipation chamber, that is, the air in an area at a lower temperature than the area where the light-emitting element is present. Even though a temperature inside the lamp chamber increases due to light emitted from the light source device, the heat is dissipated at the installation portion by the air of a lower temperature than that in the installation portion. Therefore, the light dissipation effect of the light-emitting element is enhanced.

Also, according to one or more embodiments of the present invention, the high thermal conductive member is provided or disposed in the heat dissipation chamber so that the high thermal conductive member dissipates the heat at the installation portion to the outside of the device. Therefore, the heat dissipation effect can be enhanced compared to the case where the heat dissipation chamber is hollow. Further, the heat dissipation hole communicating with the heat dissipation chamber is provided so that the circulation of the air in the heat dissipation chamber is promoted by the air flowing through the heat dissipation hole. Accordingly, the heat dissipation effect can be enhanced.

### BRIEF DESCRIPTION OF THE DRAWINGS

FIG. 1 is a horizontal sectional view of a light source device according to one or more embodiments of the present invention applied to a clearance lamp.

FIG. 2 is an exterior perspective view of a light source device of one or more embodiments of the present invention.

FIG. 3 is a partial exploded perspective view of the light source device of one or more embodiments of the present invention.

FIG. 4 is an enlarged sectional view along line IV-IV in FIG. 2.

FIG. 5 is an enlarged sectional view along line V-V in FIG. 2.

FIG. 6 is a partial exploded perspective view of a light source device of one or more embodiments of the present invention.

FIG. 7 is an enlarged sectional view along line VII-VII in FIG. 6.

### DETAILED DESCRIPTION

Hereinafter, embodiments of the present invention will be described with reference to the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

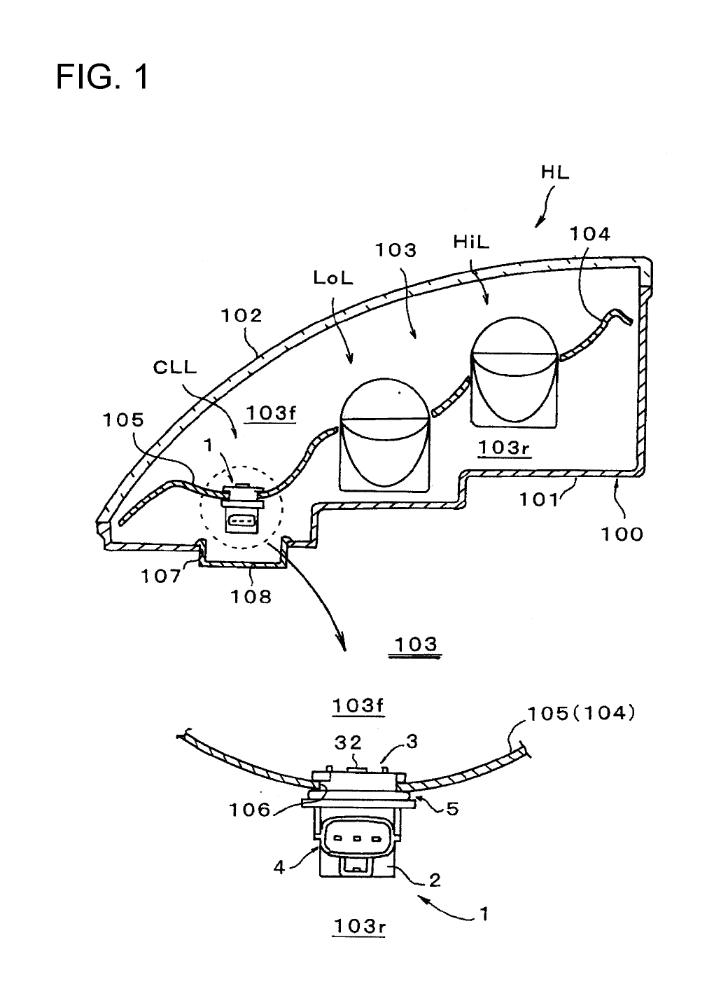

FIG. 1 is a horizontal sectional view of a light source device according to one or more embodiments of the present invention applied to a clearance lamp integrated with a head lamp of an automobile. FIG. 1 shows an example of a left head lamp HL including a lamp housing 100 formed of a lamp body 101 and a front translucent cover 102. Inside the lamp housing 100, that is, a lamp chamber 103, a low beam lamp unit LoL and a high beam lamp unit HiL are disposed, and a clearance lamp CLL is structured. In the clearance lamp CLL, a part of a pseudo-reflector 104, so-called extension, which is accommodated in the lamp housing 100, is structured as a reflector 105 of the clearance lamp. A light source attachment hole 106 is provided in the general center of the reflector 105, and a light source device 1 is detachably fitted in the light source attachment hole 106 as a light source of the clearance lamp CLL. An opening 107 is provided at a position of the back surface of the lamp body 101, which corresponds to the light source attachment hole 106, so that the light source device 1 is attached and detached. The opening 107 is closed with a detachable back cover 108. When light is emitted from the light source device 1, a portion of the emitted light is reflected by the reflector 105, and another portion of the light directly heads forward. Both portions of the light are radiated forward of an automobile in a required light distribution through the front translucent cover 102.

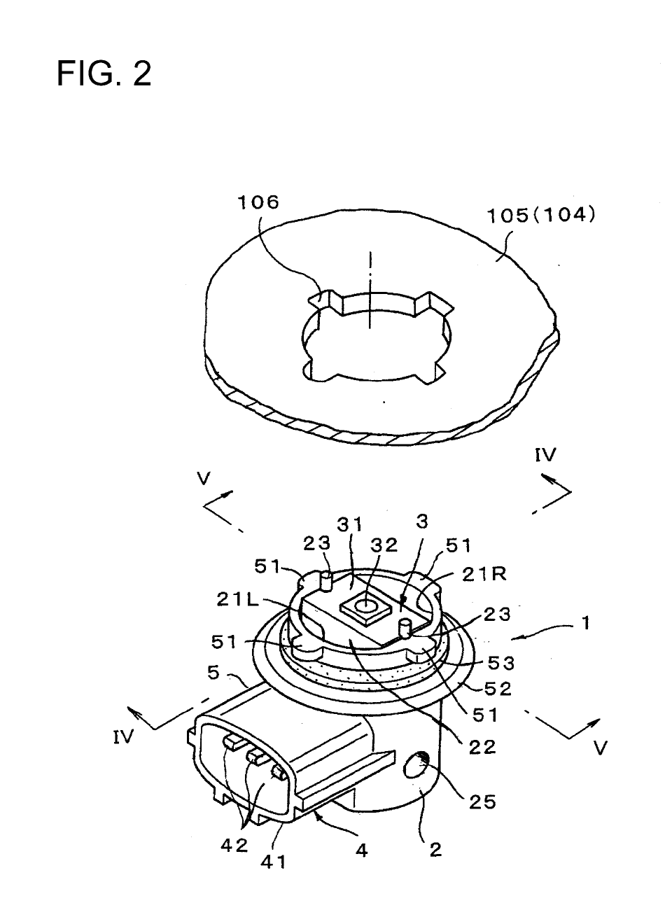

FIG. 2 is an exterior perspective view showing a state where the light source device 1 is removed from the reflector 105 and taken out from the lamp housing 100. The light source device 1 is mainly structured from a base member 2 formed by resin molding in a cylindrical shape around an axis heading in a direction along the optical axis of the clearance lamp CLL when the lamp housing 100 is mounted. An LED structure body 3 is installed in the base member 2 as a light-emitting element structure body according to one or more embodiments of the present invention. Further, a connector portion 4 is provided in a part of the peripheral wall surface of the base member 2 so as to be able to connect to an external connector 6 connected to the external power source (on-board battery, etc.) to be described later. The light source device 1 can be attached and detached to and from the light source attachment hole 106 of the lamp body 101 at a bayonet portion 5 provided in the base member 2.

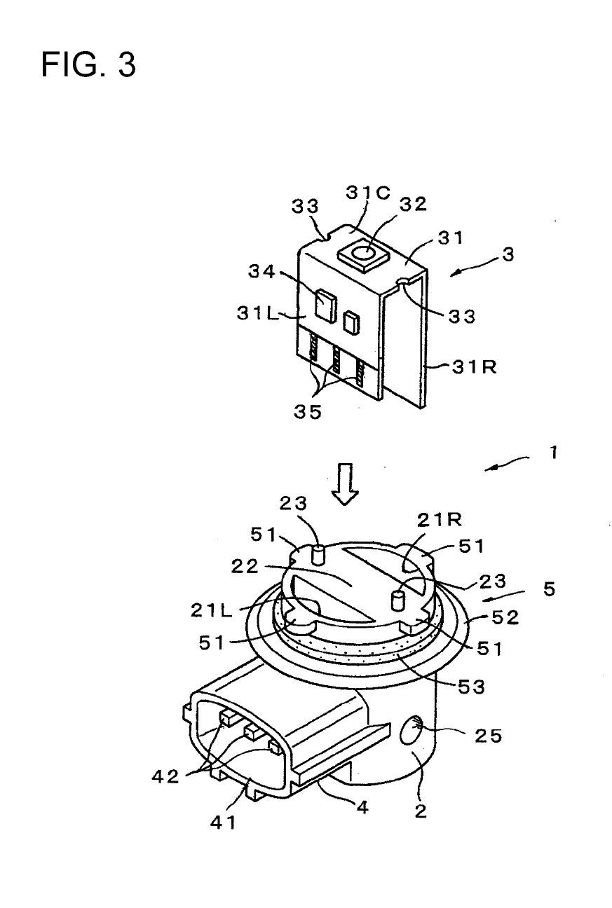

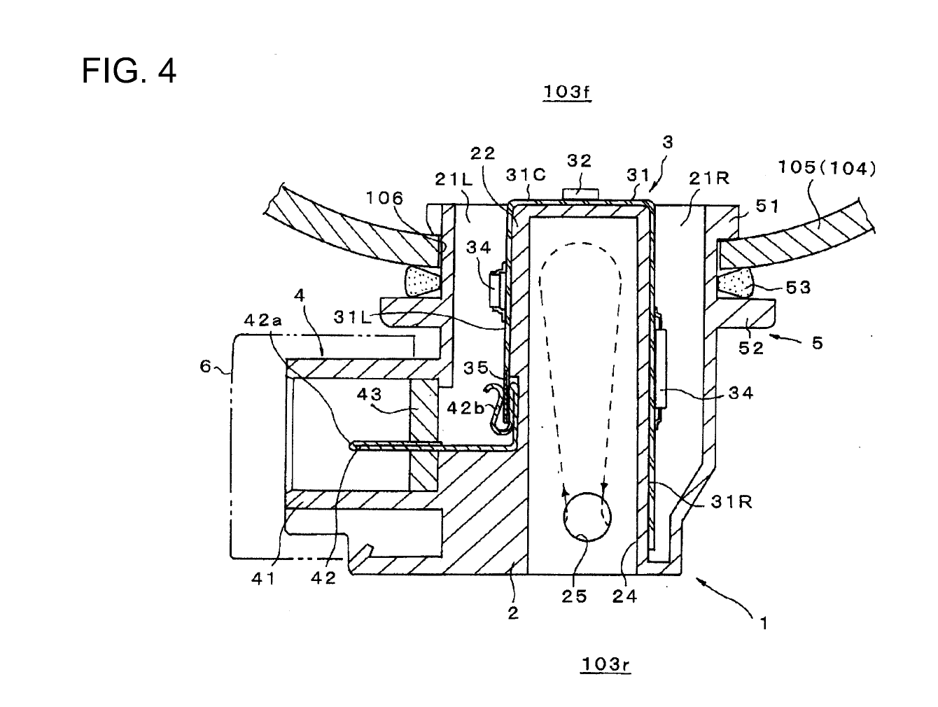

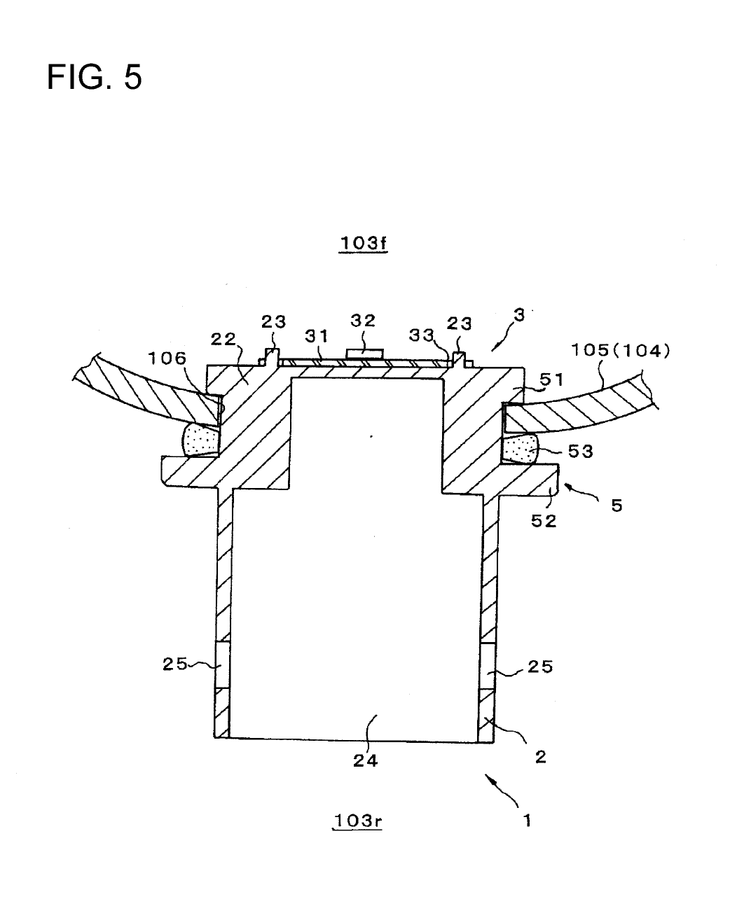

FIG. 3 is a partial exploded perspective view of the light source device 1. FIGS. 4 and 5 are an enlarged sectional view along line IV-IV and an enlarged sectional view along line V-V, respectively. A pair of grooves 21L and 21R are formed so as to provide recesses in the rear direction along the axis of the base member 2 on the front surface of the base member 2, that is, an end surface which faces the front of the lamp when the light source device 1 is fitted in the reflector 105 (an upper surface shown in FIG. 3, hereinafter, the lamp front-rear direction is used as a reference for the front-rear direction). These grooves 21L and 21R each have an arc-shaped cross section along the outer peripheral surface of the base member 2. In FIG. 3, the groove 21L on the left (hereinafter referred to as a left groove for convenience) is provided at a position in the circumferential direction where the connector portion 4 is disposed, and the other groove 21R (hereinafter referred to as a right groove for convenience) is provided at a position facing the left groove 21L in the radial direction. The portion corresponding to the center area of the base member 2 located between these grooves 21L and 21R in the radial direction is formed as an installation portion 22 so that the LED structure body 3 is installed thereon. A pair of positioning pins 23 are provided projecting from the front surface of the installation portion 22 so as to face each other in the radial direction that is orthogonal to the grooves 21L and 21R.

Commonly known bayonet pieces 51 are formed on the front end of the outer peripheral surface of the base member 2. A flange 52 is formed in a circular shape on the outer peripheral surface of the base member 2 separated by a predetermined dimension in the axial direction from the bayonet pieces 51. The bayonet portion 5 is formed of the bayonet pieces 51 and the flange 52, and allows the light source device 1 to be attached and detached to and from the light source attachment hole 106 provided in the reflector 105. For such attachment and detachment, a waterproof ring 53 is fitted to the front surface of the flange 52. The waterproof ring 53 makes it possible to achieve waterproof and airtightness effects at the light source attachment hole 106 when the light source device 1 is attached to the light source attachment hole 106.

A connector cylinder 41 is integrally formed with the connector portion 4 at a position close to the rear end of the outer peripheral surface of the base member 2, that is, a position corresponding to the left groove 21L, so that the cylinder axis heads in a direction orthogonal to the axis of the base member 2. The connector cylinder 41 has an inner portion communicating with the left groove 21L. A plurality of connector terminals 42 (three terminals) are arranged in parallel along the cylinder axis inside the connector cylinder 41 and supported by an insulating panel member 43 so as to be accommodated in the connector cylinder 41. The connector terminals 42 are formed of a conductive member, in this case, formed by bending a thin and long metal plate. Each of distal ends 42a is structured as a connecting end portion for connecting the external connector 6 shown by the chain line in FIG. 4 so as to head for the opening side of the connector cylinder 41. Further, base ends 42b are extended to an area communicating with the left groove 21L, and are bent in a concave shape generally in the thickness direction. Therefore, as described later, electrical connection with the LED structure body 3 is allowed.

As shown in FIGS. 4 and 5, a heat dissipation chamber 24 is formed over the internal area of the installation portion 22 in the base member 2. The heat dissipation chamber 24 is formed by opening the rear surface of the base member 2 so as to have a hollow shape. In the heat dissipation chamber 24, the front surface of the installation portion 22, and the left and right surfaces facing the left groove 21L and the right groove 21R each form a wall having a predetermined thickness dimension. The thickness dimension is formed as thinly as possible while mechanical strength required for the installation portion 22 is maintained. Here, as shown in FIG. 5, in the area on the front surface side of the base member 2, particularly in the area where the bayonet portion 5 is formed, the thickness dimension is formed larger than that in other areas. In addition, heat dissipation holes 25 are each provided at a position on the rear surface side from the bayonet portion 5 of the base member 2 where interference with the connector portion 4 does not occur such that the heat dissipation holes 25 extend in the direction perpendicular to the axial direction of the connector cylinder 41 penetrating the base member 2 in the radial direction. The heat dissipation holes 25 communicate with the heat dissipation chamber 24.

The LED structure body 3 includes a printed circuit board bended generally in a U shape in the thickness direction, in this case a flexible printed circuit (FPC) board 31, as shown in FIG. 3. An LED 32 is installed on a center piece 31C of the FPC board 31. Positioning recesses 33 are formed at both edges in a width direction of the center piece 31C so as to be fitted to the positioning pins 23 on the installation portion 22. Also, various electronic parts 34 configuring a light-emitting circuit of the LED 32 are installed on each of a left piece 31L and a right piece 31R between which the center piece 31C of the FPC board 31 is positioned in the longitudinal direction. A plurality of contact portions 35 are formed of a part of conductive film configuring a wiring circuit of the FPC board 31 at an end of the left piece 31L heading downward as shown in FIG. 3. As described later, the contact portions 35 are electrically connected to the connector terminals 42 of the connector portion 4. The FPC board 31 may be configured with a so-called metal base FPC board of which a thin metal plate is integrally formed on the back surface.

The LED structure body 3 is installed on the installation portion 22 from the front surface side of the base member 2. For this installation, the left piece 31L and the right piece 31R of the FPC board 31 is inserted to the left groove 21L and the right groove 21R, respectively. The back surface of the center piece 31C is in contact with the front surface of the installation portion 22. The positioning recesses 33 of the center piece 31C are fitted to the positioning pins 23 of the installation portion 22, and the LED structure body 3 is positioned to the installation portion 22. Then, the back surface of the LED structure body 3 is fixed to the installation portion 22 by adhesion, etc. By installing the LED structure body 3 as described above, the distal end of the left piece 31L is fitted in the base ends 42b of the connector terminals 42 of the connector portion 4 as shown in FIG. 4. The contact portions 35 provided in the distal end of the FPC board 31 are thus electrically connected to the connector terminals 42.

The light source device 1 having the above configuration is fitted in the light source attachment hole 106 of the clearance lamp CLL provided in the reflector 105 with the bayonet portion 5 as shown in FIG. 1. An extension 104 configuring the reflector 105 is disposed generally over the entire area inside the lamp chamber 103. Therefore, the extension 104 separates the lamp chamber 103 into the front side area and the rear side area. In one or more embodiments of the present invention, the lamp chamber 103 is separated into a front side chamber 103f and a rear side chamber 103r. The front side chamber 103f corresponds to an area that is on the front side of the extension 104, and the rear side chamber 103r corresponds to an area that is on the rear side of the extension 104. Accordingly, in a state where the light source device 1 is fitted in the light source attachment hole 106 of the reflector 105, a front side portion of the base member 2, that is, a portion including a portion where the LED 32 is disposed, which is on the front side of the bayonet portion 5, is positioned in the front side chamber 103f, and a portion including the connector portion 4 that is on the rear side of the bayonet portion 5 is positioned in the rear side chamber 103r. Although not shown in FIG. 1, the external connector 6 can be attached and detached to and from the connector portion 4 even in a state where the light source device 1 is fitted in the reflector 105 inside the lamp housing 100. When the light source device is fitted, the external connector 6 can supply electricity to the connector portion 4. Electric power supplied to the connector portion 4 is supplied from the connector terminals 42 to the contact portions 35 of the LED structure body 3 that are electrically connected to the connector terminals 42. Accordingly, light can be emitted from the LED 32.

The rear portion of the base member 2 is exposed at the rear side chamber 103r of the lamp chamber 103 as shown in FIG. 1 in a state where the light source device 1 is fitted in the reflector 105 inside the lamp housing 100. That is, the heat dissipation chamber 24 provided in the base member 2 communicates with the rear side chamber 103r through the opening in the rear surface of the base member 2 and through a pair of heat dissipation holes 25 communicating with the heat dissipation chamber 24. The LED structure body 3 is heated due to heat that is generated when light is emitted from the LED 32. The heat is transferred from the FPC board 31 of the LED structure body 3 to the installation portion 22 that is in contact with the back surface of the FPC board 31. The heat is dissipated by the air in the rear side chamber 103r which is present in the heat dissipation chamber 24 inside the installation portion 22, that is, at the surface of the side facing the heat dissipation chamber 24. In the case where the metal base FPC board is used for the FPC board 31 of the LED structure body 3, the heat generated in the LED 32 is diffused and quickly transferred to the entire area of the LED structure body 3 with the metal base. The heat can be transferred to a larger area of the installation portion 22. Therefore, the heat dissipation effect of the LED structure body 3 caused by the heat dissipation chamber 24 is enhanced. When the clearance lamp CLL is lit, the temperature in the front side chamber 103f that is on the front side of the reflector 105 is higher than that in the reflector 105 due to the heat generated in the LED 32, and the temperature in the rear side chamber 103r is lower than that in the front side chamber 103f because the heat is insulated by the reflector 105. Accordingly, the heat dissipation effect caused by the air in the rear side chamber 103r can be enhanced.

In addition, the air in the rear side chamber 103r, which is at a relatively low temperature, passes through the inside of the heat dissipation holes 25 communicating with the heat dissipation chamber 24. Accordingly, the outside air in the heat dissipation chamber 24 is circulated without stagnation as shown by the arrow in broken line in FIG. 4, and this suppresses a temperature increase of the air in the heat dissipation chamber 24. Then, the heat dissipation effect can be further enhanced. Particularly, by positioning each of the heat dissipation holes 25 in the base member 2 so as to face each other in the radial direction, passage resistance of the air flowing through the heat dissipation holes 25 decreases, and the flow speed increases. The Venturi effect caused by the air flow enables circulation of the outside air to be promoted and further enhances the heat dissipation effect.

As described above, in the light source device 1 according to one or more embodiments of the present invention, the heat can be dissipated from the light source device 1, particularly from the LED structure body 3, by the air in the rear side chamber 103r, which is at a relatively low temperature because the heat is insulated by the reflector 105, that is, by the extension 104, even though the temperature in the front side chamber 103f of the lamp chamber 103 increases due to the heat generated in the light source device 1. Therefore, the heat dissipation effect is enhanced, enabling a temperature increase in the LED structure body 3 to be suppressed.

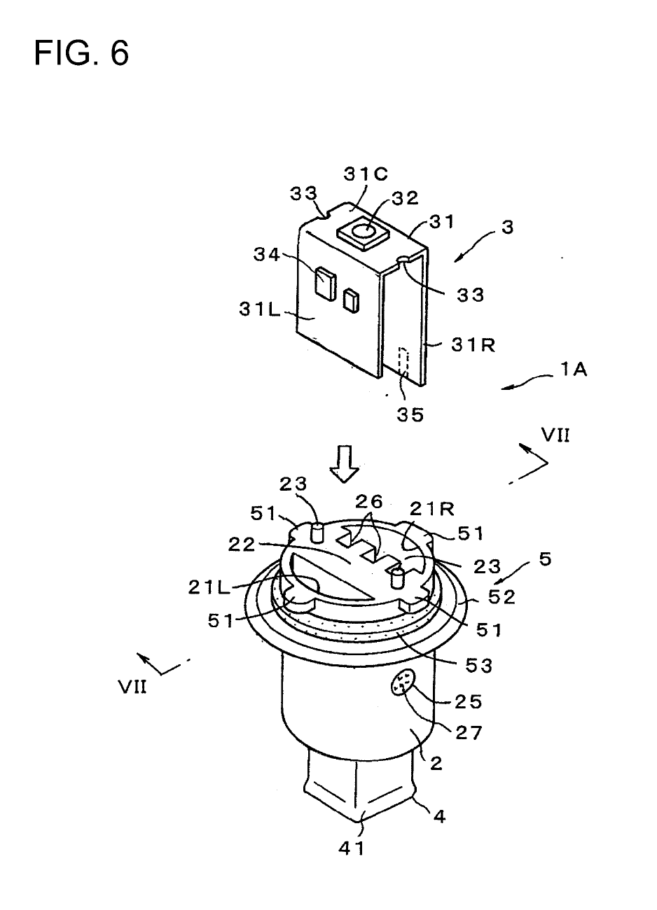

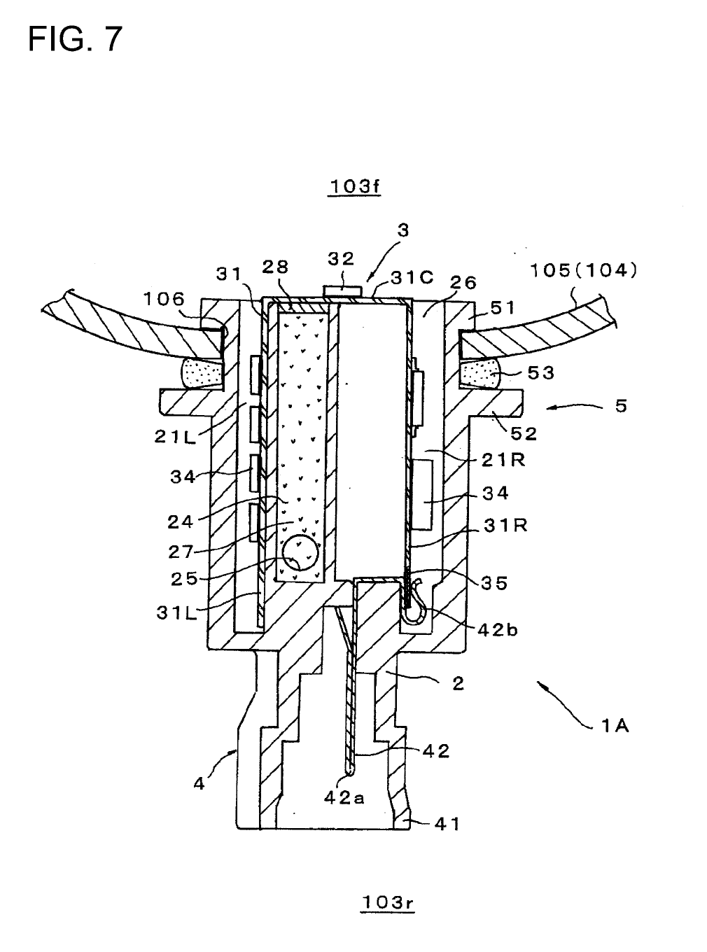

FIG. 6 is a partial exploded perspective view of a light source device according to one or more embodiments of the present invention, having the cylinder axis of the connector portion heading in the same direction as the axis of the base member. FIG. 7 is an enlarged sectional view along line VII-VII. Like reference numerals are used for portions similar to those described above. In the light source device 1A of one or more embodiments of the present invention, basically the installation portion 22 of the base member 2 and the LED structure body 3 have almost the same structures as those described above. The connector portion 4 is positioned on the rear surface of the base member 2 so as to head in the axial direction. Therefore, the shapes of the connector terminals 42 are partially changed so that the distal ends 42a of the connector terminals 42 extend in the direction along the axis of the base member 2

In addition, the connector terminals 42 are inserted from the front surface side of the base member 2 when the connector terminals 42 are accommodated in the connector portion 4. Therefore, connector insertion grooves 26 are formed in the installation portion 22 so as to extend in the axial direction in order to insert the connector terminals 42 from the front surface toward the rear surface. The connector insertion grooves 26 provided correspond to the number of the connector terminals 42. Here, three connector terminals 42 are disposed. Therefore, three connector insertion grooves 26 are provided aligned in a direction perpendicular to the paper of FIG. 7 on the surface facing the right groove 21R of the installation portion 22. Further, in the LED structure body 3, the contact portions 35 are formed at the end of the right piece 31R based on the structure of the connector portion 4.

According to one or more embodiments of the present invention, inside the installation portion 22, the heat dissipation chamber 24 is opened in an area so as not to interfere with the left groove 21L, the right groove 21R, and the connector insertion grooves 26 along the axial direction from the front surface of the installation portion 22. The heat dissipation chamber 24 is extended to a portion close to the rear surface of the base member 2, and closed and ended in the vicinity of the connection portion with the connector portion 4. The heat dissipation holes 25 penetrating the base member 2 in the radial direction are provided in a part of the outer peripheral surface of the base member 2, and the heat dissipation holes 25 communicate with the heat dissipation chamber 24.

Further, according to one or more embodiments of the present invention, a space to form the heat dissipation chamber 24 is restricted due to the connector insertion grooves 26 formed on the installation portion 22. Therefore, it is difficult to increase the volume of the heat dissipation chamber 24 and enlarge the area of the installation portion 22 contacting the heat dissipation chamber 24. Consequently, a high thermal conductive member 27, such as metal powder, metal particle, or metal plate, and high thermal conductive resin, is disposed in the heat dissipation chamber 24 from the opening formed on the front surface of the installation portion 22. In addition, for example, a lid element 28 formed of another member is adhered to the opening of the heat dissipation chamber 24 so as to close the opening. As a method for charging the high thermal conductive member 27 in the heat dissipation chamber 24, for example, the high thermal conductive resin that is melting is disposed in the heat dissipation chamber 24, and the high thermal conductive resin may be cooled and hardened. The high thermal conductive member 27 may be disposed in the heat dissipation chamber 24 excluding the heat dissipation holes 25. Here, the high thermal conductive member 27 is disposed in the area extending from the heat dissipation chamber 24 to the heat dissipation holes 25, and as shown in FIG. 6, a part of the high thermal conductive member 27 is exposed at the circumference of the base member 2 in the heat dissipation holes 25.

In the light source device 1A according to one or more embodiments of the present invention, excluding that the external connector 6 (see FIG. 4) is fitted to the connector portion 4 from the rear surface side along the axial direction of the base member 2, the light source device 1A is fitted in the reflector 105 inside the lamp housing 100 and light is emitted form the LED structure body 3 in a similar manner as described above. The heat to be generated when light is emitted from the LED 32 is transferred from the LED structure body 3 to the installation portion 22. Further, the heat is dissipated from the heat dissipation chamber 24 located inside the installation portion 22 and the heat dissipation holes 25. However, in one or more embodiments of the present invention, referring to FIG. 1, the heat transferred from the LED structure body 3 to the installation portion 22 is transferred to the high thermal conductive member 27 disposed in the heat dissipation chamber 24, and is transferred up to the heat dissipation holes 25 through the high thermal conductive member 27. Then, the heat is dissipated by the air in the rear side chamber 103r from the surface at which the high thermal conductive member 27 is exposed from the heat dissipation holes 25. When the high thermal conductive member 27 is not disposed up to the heat dissipation holes 25, the heat is dissipated by the air in the rear side chamber 103r, which flows through the heat dissipation holes 25. As described above, by charging the high thermal conductive member 27 in the heat dissipation chamber 24, the heat conductivity from the installation portion 22 to the heat dissipation chamber 24 and the heat dissipation holes 25 is enhanced, and the heat dissipation effect can be further enhanced compared to the case where the heat dissipation chamber 24 is hollow as described above.

Here, the opening of the heat dissipation chamber 24 that opens in the front surface of the installation portion 22 is closed with the lid element 28 after the high thermal conductive member 27 is disposed in the heat dissipation chamber 24. However, the opening is closed by hardening when the high thermal conductive resin is used for the high thermal conductive member 27. Therefore, the lid element 28 is not required. In addition, even though the high thermal conductive member 27 other than resin is disposed, and the opening is kept open, the opening can be airtightly sealed by closely contacting the back surface of the FPC board 31 when the LED structure body 3 is installed on the installation portion thereafter. Therefore, in this case as well, the lid element 28 may not be required.

The structure in which the high thermal conductive member 27 is disposed in the heat dissipation chamber 24 to enhance the heat dissipation effect may be similarly applied to the light source device 1 in any of the embodiments of the present invention, even if not shown in the drawings. In the case where the high thermal conductive member 27 is disposed in the heat dissipation chamber 24 according to one or more embodiments of the present invention, the heat transferred from the LED structure body 3 to the installation portion 22 is transferred from the installation portion 22 up to the rear surface of the base member 2 at which the high thermal conductive member 27 is exposed. The heat is dissipated by the air in the rear side chamber 103r from the rear surface. Note that the heat dissipation holes 25 communicating with the heat dissipation chamber 24 may not be particularly provided because heat conductive efficiency up to the rear surface of the base member 2 is enhanced by the high thermal conductive member 27.

One or more of the above embodiments describe the example of the structure in which the light source attachment hole 106 is provided in the reflector 105, that is, the extension 104, accommodated in the lamp housing 100, and the light source device 1 is fitted in the light source attachment hole 106. However, one or more embodiments of the present invention may be applied to a lamp having a structure in which the light source device 1 is fitted to a support member provided separately from the reflector and disposed inside the lamp housing, for example, a support frame or a support portion provided integrally with an inner lens. In this case as well, when the reflector or the support member separates the lamp chamber 103 into the front side chamber 103f in which the LED is positioned and the rear side chamber 103r isolated from the front side chamber 103f by the reflector or the support member, the heat dissipation effect of the light source device 1 can be enhanced by adopting a structure in which the heat dissipation chamber provided in the light source device is exposed at the rear side chamber.

In addition, one or more embodiments of the present invention may be applied to a lamp having a structure in which the light source attachment hole is provided in the rear surface of the lamp body 101, and the light source device is fitted in the light source attachment hole. In this case, the front side chamber in the light source device 1 corresponds to the inside of the lamp housing 100, that is, the lamp chamber 103, and the rear side chamber corresponds to the outside of the lamp housing 100, that is, the outside air area. Accordingly, the heat in the heat dissipation chamber in the light source device 1 is dissipated by the outside air outside the lamp housing 100.

In one or more of the embodiments described above, the example including the bayonet portion 5 for fitting the light source device 1 or 1A in the light source attachment hole 106 is shown. However, as long as the light source device is fitted in the light source attachment hole 106, installation structures using screws or other methods may be adopted. In addition, in one or more of the above embodiments, the bayonet portion 5 is disposed on a position close to the front end of the base member 2. However, the bayonet portion 5 may be disposed on the center position in the front-rear direction or a position close to the rear end. Further, the connector portion 4 is not limited to a structure in which the external connector 6 is fitted to the connector portion 4, and may be a cable connector directly running the electric cable from the LED structure body 3.

One or more of the embodiments described above shows an example in which the chip based LED is installed to the FPC board in the LED structure body as the light-emitting element structure body. However, a discrete LED may be used, or a light source device on which a semiconductor limit-emitting element is installed may be used. Further, the FPC board is not limited to a metal base FPC or a FPC having a reinforcement plate on its back surface but may be configured with the normal printed circuit board (PCB).

Above, one or more embodiments of the present invention is applied to a light source device of a clearance lamp. However, for the light source device of the lamp that adopts the semiconductor light-emitting element including LED as a light source, one or more embodiments of the present invention may be configured as a light source device of other lamps such as a tail lamp (including a stop lamp, back-up lamp), a daytime running lamp (DRL) or a turn signal lamp (TSL).

In one or more embodiments of the present invention, the semiconductor light-emitting element is used as a light source, and the light source may be adopted for a lamp and its light source device which are accommodated in the lamp chamber.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF THE REFERENCE NUMERALS

1, 1A LIGHT SOURCE DEVICE
2 BASE MEMBER
3 LIGHT-EMITTING ELEMENT STRUCTURE BODY (LED STRUCTURE BODY)
4 CONNECTOR PORTION
5 BAYONET PORTION
6 EXTERNAL CONNECTOR
22 INSTALLATION PORTION
24 HEAT DISSIPATION CHAMBER
25 HEAT DISSIPATION HOLE
27 HIGH THERMAL CONDUCTIVE MEMBER
31 FPC BOARD
32 LIGHT-EMITTING ELEMENT (LED)
34 ELECTRONIC PART
35 CONTACT PORTION
41 CONNECTOR CYLINDER
42 CONNECTOR TERMINAL
51 BAYONET PIECE
100 LAMP HOUSING
101 LAMP BODY
103 LAMP CHAMBER
103f FRONT SIDE CHAMBER
103r REAR SIDE CHAMBER
104 EXTENSION
105 REFLECTOR
106 LIGHT SOURCE ATTACHMENT HOLE
CLL CLEARANCE LAMP
HL HEADLAMP

1. A light source device comprising:
a light-emitting element structure body comprising a light-emitting element;
a base member configured to be fitted in a lamp; and
an installation portion disposed on the base member,
wherein the light-emitting element structure body is installed on the installation portion,
wherein the base member comprises a heat dissipation chamber communicating with an outside of the device, and
wherein the heat dissipation chamber is formed inside the installation portion.

2. The light source device according to claim 1, wherein a high thermal conductive member partially exposed to the outside of the device is provided or disposed in the heat dissipation chamber.

3. The light source device according to claim 1, wherein a heat dissipation hole is provided in the base member so that the heat dissipation chamber communicates with the outside of the device.

4. The light source device according to claim 1,
wherein the base member is mounted on a part of a member that separates a lamp chamber into a front side chamber and a rear side chamber, and
wherein, in a state where the base member is mounted on the part of the member, the light-emitting element structure body is positioned in the front side chamber of the lamp, and the heat dissipation chamber communicates with the rear side chamber of the lamp.

5. A vehicular lamp comprising:
the light source device according to claim 1.

6. The light source device according to claim 2, wherein a heat dissipation hole is provided in the base member so that the heat dissipation chamber communicates with the outside of the device.

7. The light source device according to claim 2,
wherein the base member is mounted on a part of a member that separates a lamp chamber into a front side chamber and a rear side chamber, and
wherein, in a state where the base member is mounted on the part of the member, the light-emitting element structure body is positioned in the front side chamber of the lamp, and the heat dissipation chamber communicates with the rear side chamber of the lamp.

8. The light source device according to claim 3,
wherein the base member is mounted on a part of a member that separates a lamp chamber into a front side chamber and a rear side chamber, and
wherein, in a state where the base member is mounted on the part of the member, the light-emitting element structure body is positioned in the front side chamber of the lamp, and the heat dissipation chamber communicates with the rear side chamber of the lamp.

9. A vehicular lamp comprising:
the light source device according to claim 2.

10. A vehicular lamp comprising:
the light source device according to claim 3.

11. A vehicular lamp comprising:
the light source device according to claim 4.
